(19) United States
(12) Patent Application Publication
(10) Pub. No.: US 2023/0283913 A1
(43) Pub. Date: Sep. 7, 2023

(54) IMAGE CAPTURE APPARATUS AND ACCESSORY APPARATUS

(71) Applicant: CANON KABUSHIKI KAISHA, Tokyo (JP)

(72) Inventors: Nobuyuki HORIE, Tokyo (JP); Akihiro TANABE, Tokyo (JP)

(21) Appl. No.: 18/162,732

(22) Filed: Feb. 1, 2023

(30) Foreign Application Priority Data
Mar. 3, 2022 (JP) 2022-032810

(51) Int. Cl. H04N 23/80; G06T 5/00; H04N 23/66; G06T 1/60

(52) U.S. Cl. CPC H04N 23/80; G06T 1/60; G06T 5/001; H04N 23/66; G06T 2207/20081; G06T 2207/20084

(57) ABSTRACT

An image capture apparatus comprises a connection unit that connects to an accessory apparatus, an image processing unit that executes image processing using a learning model, and a control unit that acquires a learning model to be used by the image processing unit in image processing from the accessory apparatus connected to the image capture apparatus.

### BACKGROUND OF THE INVENTION

### Field of the Invention

The present invention relates to a system in which an accessory apparatus and an image capture apparatus are connected.

### Description of the Related Art

In a system in which an accessory apparatus is connected to an image capture apparatus, data and the like for controlling the accessory apparatus is exchanged between the image capture apparatus and the accessory apparatus. When the accessory apparatus is an interchangeable lens and the interchangeable lens is used to capture an image, the image capture apparatus needs to acquire optical information relating to optical characteristics of the lens from the interchangeable lens and execute image processing appropriate for the image on the basis of the optical characteristics.

With an image capture apparatus to which such an accessory apparatus can be detachably attached, when executing image processing using a neural network such as Generative Adversarial Networks (GAN), using a single neural network to execute image processing based on the optical information of various types of lenses that can be connected to the image capture apparatus results in the scale of the model being too large.

In Japanese Patent Laid-Open No. 2021-72600, a system is described which connects to an external device that can transmit a plurality of learning models and receives a model selected from a list.

However, with Japanese Patent Laid-Open No. 2021-72600, it is necessary to connect to an external device that can transmit a plurality of learning models and select a target model from a list. Thus, in an environment in which a network connection cannot be established, a learning model cannot be acquired. Also, since it is necessary to select a model appropriate for each one of the various lens types, user-friendliness is reduced and a camera cannot be used just after a lens is connected.

### SUMMARY OF THE INVENTION

The present invention has been made in consideration of the aforementioned problems, and realizes techniques for providing an optimal learning model for each accessory apparatus which is connectable to an image capture apparatus.

In order to solve the aforementioned problems, the present invention provides an image capture apparatus comprising: a connection unit that connects to an accessory apparatus; an image processing unit that executes image processing using a learning model; and a control unit that acquires a learning model to be used by the image processing unit in image processing from the accessory apparatus connected to the image capture apparatus.

In order to solve the aforementioned problems, the present invention provides an accessory apparatus which is connectable to an image capture apparatus, comprising: a storage unit that stores a learning model appropriate for a type of the accessory apparatus; and a control unit that transmits the learning model stored in the storage unit to the image capture apparatus in response to a request from the image capture apparatus.

In order to solve the aforementioned problems, the present invention provides a method of controlling an image capture apparatus provided with a connecting unit that connects to an accessory apparatus and an image processing unit that executes image processing using a learning model, the method comprising: acquiring a learning model to be used by the image processing unit in image processing from the accessory apparatus connected to the image capture apparatus.

In order to solve the aforementioned problems, the present invention provides a method of controlling an accessory apparatus which is connectable to an image capture apparatus, the method comprising: receiving a request for a learning model appropriate for a type of the accessory apparatus from the image capture apparatus; and transmitting a learning model stored in a storage unit to the image capture apparatus in response to a request from the image capture apparatus.

In order to solve the aforementioned problems, the present invention provides a non-transitory computer-readable storage medium storing a program that causes a computer to execute a method of controlling an image capture apparatus provided with a connecting unit that connects to an accessory apparatus and an image processing unit that executes image processing using a learning model, the method comprising: acquiring a learning model to be used by the image processing unit in image processing from the accessory apparatus connected to the image capture apparatus.

In order to solve the aforementioned problems, the present invention provides a non-transitory computer-readable storage medium storing a program that causes a computer to execute a method of controlling an accessory apparatus which is connectable to an image capture apparatus, the method comprising: receiving a request for a learning model appropriate for a type of the accessory apparatus from the image capture apparatus; and transmitting a learning model stored in a storage unit to the image capture apparatus in response to a request from the image capture apparatus.

According to the present invention, an optimal learning model for each accessory apparatus which is connectable to an image capture apparatus can be provided.

Further features of the present invention will become apparent from the following description of exemplary embodiments (with reference to the attached drawings).

### BRIEF DESCRIPTION OF THE DRAWINGS

FIG. 1 is a block diagram illustrating a system configuration and apparatus configuration according to a first embodiment.

FIG. 2 is a diagram illustrating a communication interface between a lens apparatus and a camera apparatus according to the first embodiment.

FIG. 3 is a flowchart illustrating the operations of the lens apparatus and the camera apparatus according to the first embodiment.

FIG. 4 is a flowchart illustrating the operations of a camera apparatus according to a second embodiment.

FIGS. 5A and 5B are diagrams illustrating a method of learning for a neural network model according to the second embodiment.

FIG. 6 is a diagram illustrating information relating to the neural network model according to the second embodiment.

FIG. 7 is a diagram illustrating a method of storing a neural network model using a lens apparatus and a camera apparatus according to a third embodiment.

FIG. 8 is a flowchart illustrating the operations of the camera apparatus according to the third embodiment.

FIG. 9 is a diagram illustrating a management UI of the neural network model according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

First, the first embodiment will now be described.

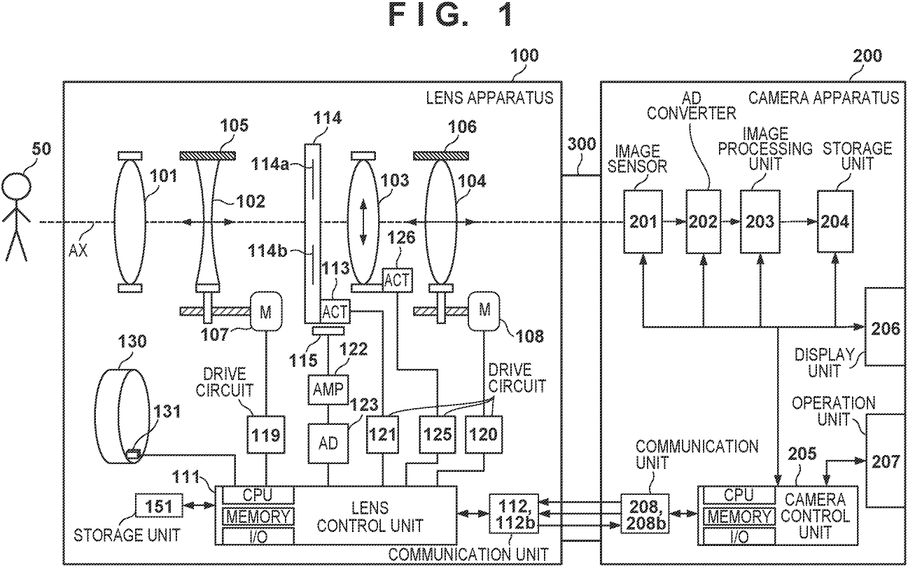

FIG. 1 illustrates the configuration of a system including an accessory apparatus and an image capture apparatus according to the first embodiment.

In the present embodiment, an accessory apparatus 100 is an interchangeable lens (hereinafter, referred to as a lens apparatus) that can detachably attached to an image capture apparatus 200, and the image capture apparatus 200 is a single-lens reflex digital camera (hereinafter, referred to as a camera apparatus) with an exchangeable lens. Note that the image capture apparatus of the present invention is not limited to the single-lens reflex digital camera and may be a smartphone or the like. Also, the accessory apparatus of the present invention is not limited to the interchangeable lens and may be an optical filter or the like. The lens apparatus 100 and the camera apparatus 200 can be mechanically and electrically connected via a mount 300 provided on both, and asynchronous communication is used.

### Apparatus Configuration

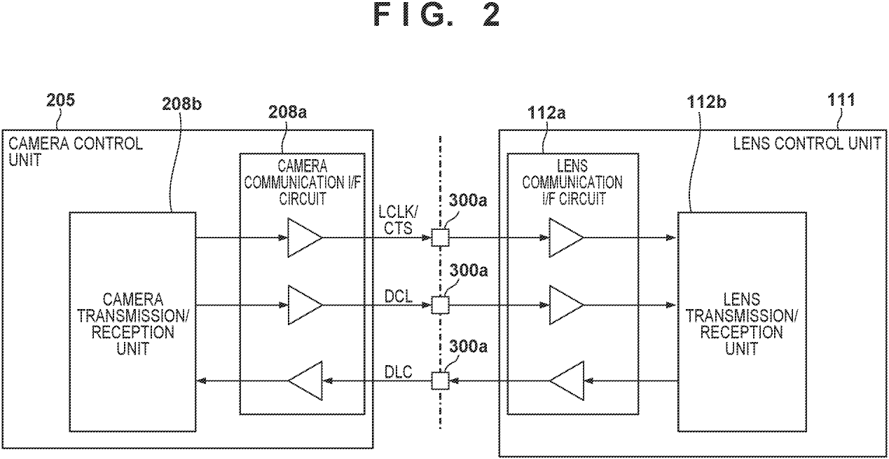

Next, the configuration and functions of the lens apparatus 100 and the camera apparatus 200 forming the system of the present embodiment will be described with reference to FIG. 2.

The lens apparatus 100 receives power from the camera apparatus 200 via a not-illustrated power supply terminal provided on the mount 300 and supplies power to the components of the lens apparatus 100 which will be described later. Also, the lens apparatus 100 and the camera apparatus 200 communicate via a not-illustrated communication terminal provided on the mount 300.

The lens apparatus 100 includes an optical system for forming an optical image for image capturing. The optical system includes, in order from closest to a subject 50, a field lens 101, a zoom lens 102, a diaphragm unit 114, an image blur correction lens 103, and a focus lens 104.

The zoom lens 102 is supported by a lens support frame 105. The focus lens 104 is supported by a lens support frame 106.

The lens support frames 105 and 106 are guided by not-illustrated guide shafts allowing movement in an optical axis direction AX and are driven in the optical axis direction AX by stepping motors 107 and 108.

The stepping motor 107 is in sync with a drive pulse of a zoom drive circuit 119, drives the lens support frame 105, and moves the zoom lens 102 in a reciprocating motion in the optical axis direction AX. The stepping motor 108 is in sync with a drive pulse of a focus drive circuit 120 and moves the focus lens 104 in a reciprocating motion in the optical axis direction AX via the lens support frame 106.

The image blur correction lens 103 moves in a direction orthogonal to the optical axis direction AX via an anti-vibration actuator 126 to reduce the image blur caused by hand shake and the like.

A lens control unit 111 includes a microcomputer including a processor (for example, a CPU) that controls the entire lens apparatus 100, a memory, an interface circuit, and the like. The processing of the flowchart which will be described later is implemented by the lens control unit 111 executing a program stored in the memory. Note that instead of the lens control unit 111 controlling the entire lens apparatus 100, a plurality of hardware may share the processing to control the entire apparatus.

The lens control unit 111 receives transmission requests for camera data and lens data transmitted from the camera apparatus 200 via a lens communication unit 112. The lens control unit 111 controls the lens apparatus 100 according to the camera data and transmits the lens data to the camera apparatus 200.

The lens control unit 111 performs operations relating to communication with the camera apparatus 200 (a camera control unit 205) in accordance with a communication control program, that is, a computer program. Also, the lens control unit 111 outputs a control signal to the zoom drive circuit 119 and the focus drive circuit 120 according to the camera data relating to zoom control or focus control received from the camera apparatus 200, the zoom drive circuit 119 and the focus drive circuit 120 output a drive pulse to the stepping motors 107 and 108, the zoom processing is executed by operating the zoom lens 102 to zoom, and autofocus (AF) processing is executed by operating the focus lens 104 to focus.

The lens apparatus 100 includes a manual focus ring 130 by which a user can perform a rotational operation and a focus encoder 131 that detects the rotational operation amount of the manual focus ring 130.

The lens control unit 111 drives the stepping motor 108 via the focus drive circuit 120 according to the rotational operation amount of the manual focus ring 130 detected by the focus encoder 131 and moves the focus lens 104. Manual focus (MF) is performed in this manner.

The diaphragm unit 114 includes diaphragm blades 114a and 114b. The operating state of the diaphragm blades 114a and 114b is detected by a hall element 115 and input into the lens control unit 111 via an amplifier circuit 122 and an AD converter 123.

The lens control unit 111 outputs a control signal to a diaphragm drive circuit 121 on the basis of an input signal from the AD converter 123, the diaphragm drive circuit 121 outputs a drive pulse to a diaphragm actuator 113, and the diaphragm blades 114a and 114b of the diaphragm unit 114 are operated to execute light amount adjustment processing.

Also, the lens control unit 111 outputs a control signal to an anti-vibration drive circuit 125 according to the camera shake detected by a shake sensor (not illustrated) such as a vibration gyroscope provided in the lens apparatus 100, and the anti-vibration drive circuit 125 outputs a drive pulse to the anti-vibration actuator (voice coil motor or the like) 126 to execute anti-vibration processing to move the image blur correction lens 103.

A storage unit 151 is a ROM or the like and stores various types of programs run by the lens control unit 111, lens unique information, and models (learning models) of a neural network such as a Convolutional Neural Network (CNN). Note that the storage unit 151 is not limited to the ROM and may be a memory card, a hard disk, or the like, for example. The neural network (NN) includes an input layer, an output layer, and an intermediate layer. Data is input in the input layer, a feature value included in the data is extracted by the intermediate layer, and a final result is calculated by the output layer. Also, a neural network model (NN model) performs machine learning or deep learning to acquire a desired result for input data and includes the structures and parameters (weighting coefficients and biases) of each layer.

The camera apparatus 200 includes an image sensor 201, an AD converter 202, an image processing unit 203, a storage unit 204, the camera control unit 205, and a display unit 206.

The image sensor 201 includes a photoelectric conversion element, such as a CCD, CMOS, or the like for performing photoelectric conversion of a subject image formed by the optical system of the lens apparatus 100 and outputting an electrical signal (analog signal). The AD converter 202 converts the analog signal from the image sensor 201 into a digital signal.

The image processing unit 203 executes image processing on the digital signal from the AD converter 202 and generates an image signal. The image processing unit 203 executes image processing using an NN model. The image processing unit 203 includes a Graphics Processing Unit (GPU). The GPU is a processor that can execute processing specific to computer graphics calculations and includes the calculation processing power to perform matrix operations and the like required for the neural network in a short amount of time. Note that the image processing unit 203 is not limited to the GPU, and it is sufficient that a circuit configuration that performs matrix operations and the like required for the neural network is provided.

The image signal generated by the image processing unit 203 is output to the display unit 206 and stored in the storage unit 204 at an arbitrary timing.

The display unit 206 includes a liquid crystal or organic EL display device, for example, for displaying the image signal as a live view image. The user can confirm the composition, focus status, and the like by looking at the live view image.

The storage unit 204 includes a ROM that stores programs executed by the camera control unit 205, constants for operations necessary to execute the programs, and the like and a RAM that stores the lens data and NN models received from the image signal and the lens apparatus 100 and loads constants, variables, and programs read out from the ROM for camera control unit 205 operations. Note that the storage unit 204 is not limited to the ROM and RAM and may be a memory card, a hard disk, or the like.

The camera control unit 205 includes a microcomputer including a processor (for example, a CPU) that controls the entire camera apparatus 200, a memory, an interface circuit, and the like. The processing of the flowchart which will be described later is implemented by the camera control unit 205 executing a program stored in the memory. Note that instead of the camera control unit 205 controlling the entire camera apparatus 200, a plurality of hardware may share the processing to control the entire apparatus.

The camera control unit 205 controls the camera apparatus 200 according to the operation inputs from an operation unit 207 including a not-illustrated shutter switch, various types of setting switches, and the like in response to a user operation. Also, the camera control unit 205, via a camera communication unit 208, transmits camera data relating to a zoom operation of the zoom lens 102 according to an operation input of a not-illustrated zoom lever to the lens control unit 111.

Also, the camera control unit 205, via the camera communication unit 208, transmits camera data relating to a light amount adjustment operation of the diaphragm unit 114 and an AF operation of the focus lens 104 to the lens control unit 111. The camera control unit 205 executes processing for communication with the lens control unit 111 in accordance with a program stored in the storage unit 204.

Furthermore, the camera control unit 205, via the camera communication unit 208, transmits an NN model acquisition request to the lens control unit 111 and acquires an NN model from the lens apparatus 100. The camera control unit 205 executes image processing using the NN model acquired by the image processing unit 203 from the lens apparatus 100.

Next, the communication circuit formed between the camera control unit 205 of the camera apparatus 200 and the lens control unit 111 of the lens apparatus 100 and the communication processing will be described with reference to FIG. 2.

The camera control unit 205 includes a function for managing communications with the lens control unit 111 and a function for performing a lens data transmission request and the like to the lens control unit 111. The lens control unit 111 includes a function for generating lens data and a function for transmitting lens data.

The camera control unit 205 includes a camera communication interface circuit 208a, and the lens control unit 111 includes a lens communication interface circuit 112a.

A camera data transmission/reception unit 208b of the camera control unit 205 and a lens data transmission/reception unit 112b of the lens control unit 111 communicate via a communication terminal 300a provided on the mount 300, the camera communication interface circuit 208a, and the lens communication interface circuit 112a.

In the present embodiment, the camera control unit 205 and the lens control unit 111 perform 3-wire asynchronous serial communication using three channels.

The camera communication unit 208 is configured of the camera communication unit 208 and the camera communication interface circuit 208a, and the lens communication unit 112 is configured as an accessory communication unit of the lens communication unit 112 and the lens communication interface circuit 112a.

The first channel of the three channels is a transmission request channel as a notification channel.

The second channel is a first data communication channel used in transmitting lens data from the lens control unit 111 to the camera control unit 205.

The third channel is a second data communication channel used in transmitting camera data from the camera control unit 205 to the lens control unit 111.

The lens data (accessory data) transmitted from the lens control unit 111 to the camera control unit 205 via the first data communication channel is referred to as a lens data signal DLC. Also, the camera data transmitted from the camera control unit 205 to the lens control unit 111 via the second data communication channel is referred to as a camera data signal DCL.

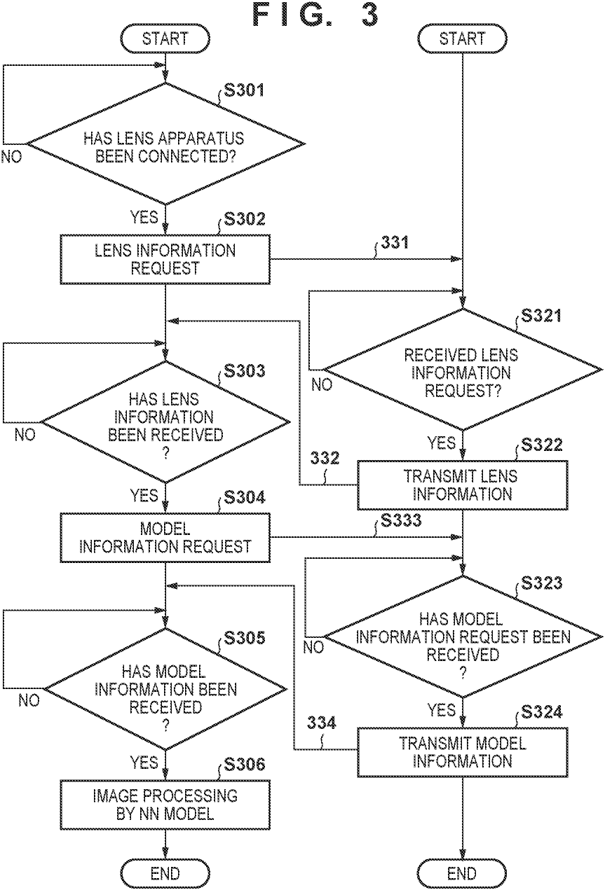

Next, the communication processing between the camera apparatus 200 (camera control unit 205) and the lens apparatus 100 (lens control unit 111) will be described with reference to FIG. 3.

Steps S301 to S306 indicate the processing of the camera control unit 205 of the camera apparatus 200, steps S321 to S324 indicate the processing of the lens control unit 111 of the lens apparatus 100, and steps S331 to S334 indicate the communication processing of the camera apparatus 200 and the lens apparatus 100.

First, the processing of the camera apparatus 200 will be described.

In step S301, the camera control unit 205 determines whether or not the lens apparatus 100 is connected to the mount 300. The camera control unit 205 can determine that the lens apparatus 100 is connected to the mount 300 by the signal voltage of the communication terminal of the mount 300 changing, for example. When the camera control unit 205 determines that the lens apparatus 100 is connected to the mount 300, the camera control unit 205 proceeds the processing to step S302. The processing of step S301 is repeated until the camera control unit 205 determines that the lens apparatus 100 is connected to the mount 300.

In step S302, the camera control unit 205 transmits a lens information request 331 for requesting the lens type information to the lens apparatus 100. The lens type information is information for determining the type of the lens the lens apparatus 100 is provided with and is the lens model information, for example. The camera apparatus 200 can acquire the zoomable range and the f-number of the lens apparatus 100 connected to the camera apparatus 200 on the basis of the lens type information. The camera control unit 205 transmits the camera data signal DCL including the lens information request 331.

In step S303, the camera control unit 205 determines whether or not lens information 332 has been received from the lens apparatus 100. The camera control unit 205 can determine that the lens information 332 has been received by the lens data signal DLC being received from the lens apparatus 100. When the camera control unit 205 determines that the lens information 332 has been received from the lens apparatus 100, the camera control unit 205 proceeds the processing to step S304. The processing of step S303 is repeated until the camera control unit 205 determines that the lens information 332 has been received from the lens apparatus 100.

In step S304, the camera control unit 205 acquires information relating to the NN model held by the lens apparatus 100 from the lens apparatus 100 connected to the camera apparatus 200 on the basis of the lens information 332 received from the lens apparatus 100. The information relating to the NN model is information relating to the number of layers and amount of processing time required. When the camera control unit 205 determines that calculation processing using the image processing unit 203 can be executed on the basis of the information relating to the NN model, the camera control unit 205 transmits a model information request 333 for requesting the NN model to the lens apparatus 100.

In step S305, the camera control unit 205 determines whether or not model information 334 has been received from the lens apparatus 100. The camera control unit 205 can determine that the model information 334 has been received from the lens apparatus 100 by the lens data signal DLC being received from the lens apparatus 100. Note that when the data amount of the model information 334 is large, the camera control unit 205 switches the direction of the camera data signal DCL and transmits the model information 334 from the lens apparatus 100 to the camera apparatus 200 using two channels, enabling the data transmission time to be shortened. When the camera control unit 205 determines that the model information 334 has been received from the lens apparatus 100, the camera control unit 205 proceeds the processing to step S306. The processing of step S305 is repeated until the camera control unit 205 determines that the model information 334 has been received from the lens apparatus 100.

In step S306, the camera control unit 205 executes image processing using the NN model included in the model information 334 received from the lens apparatus 100 using the image processing unit 203, and the camera control unit 205 terminates the processing.

Next, the processing of the lens apparatus 100 will be described.

In step S321, the lens control unit 111 determines whether or not the lens information request 331 has been received from the camera apparatus 200. The lens control unit 111 can determine that the lens information request 331 has been received from the camera apparatus 200 by the camera data signal DCL being received from the camera apparatus 200. When the lens control unit 111 determines that the lens information request 331 has been received from the camera apparatus 200, the lens control unit 111 proceeds the processing to step S322. The processing of step S321 is repeated until the lens control unit 111 determines that the lens information request 331 has been received from the camera apparatus 200.

In step S322, the lens control unit 111 transmits the lens data signal DLC as the lens information 332 to the camera apparatus 200.

In step S323, the lens control unit 111 determines whether or not the model information request 333 has been received from the camera apparatus 200. The lens control unit 111 can determine that the model information request 333 has been received from the camera apparatus 200 by the camera data signal DCL being received from the camera apparatus 200. When the lens control unit 111 determines that the model information request 333 has been received from the camera apparatus 200, the lens control unit 111 proceeds the processing to step S324. The processing of step S323 is repeated until the lens control unit 111 determines that the model information request 333 has been received from the camera apparatus 200.

In step S324, the lens control unit 111 transmits the lens data signal DLC including the model information 334 to the camera apparatus 200, and the lens control unit 111 terminates the processing.

As described above, according to the first embodiment, the lens apparatus 100 holds the NN model, and the camera apparatus 200 acquires the NN model from the lens apparatus 100 when the camera apparatus 200 connects to the lens apparatus 100.

According to this configuration, even in an environment in which a network connection with an external device cannot be established, the optimal NN model can be acquired from the lens apparatus 100 connected to the camera apparatus 200.

Also, each time the lens apparatus 100 is connected to the camera apparatus 200, there is no need to select, for each one of the lens, a model appropriate for the characteristics of the lens. This improves the user-friendliness.

### Second Embodiment

Next, the second embodiment will now be described.

In the second embodiment, cases in which image processing using an NN model appropriate for the performance of both the lens apparatus 100 and the camera apparatus 200 is executed, will be described.

In the present embodiment, the lens apparatus 100 includes a plurality of NN models. However, the lens apparatus 100 is not required to constantly hold a plurality of NN models, and it is sufficient that the lens apparatus 100 includes one NN model. The processing when the lens apparatus 100 does not include an NN model will also be described below.

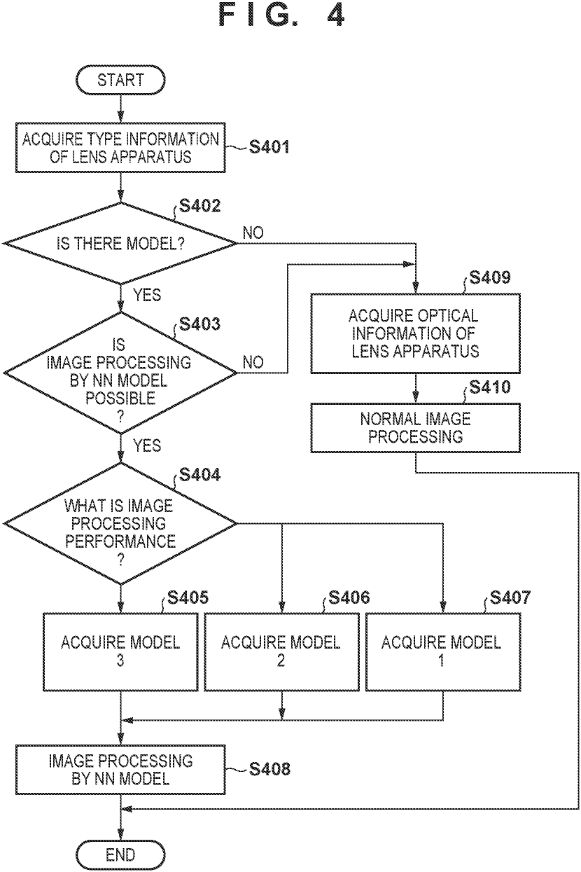

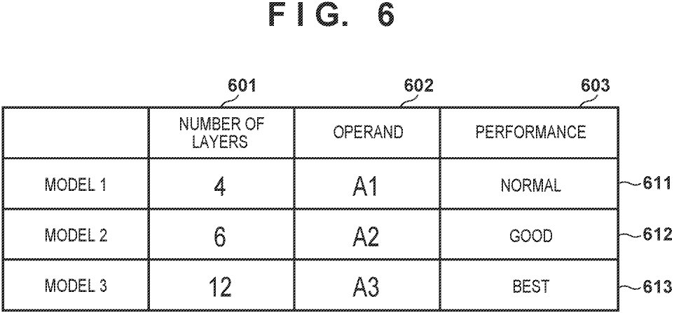

FIG. 6 illustrates an example of information relating to NN models when the lens apparatus 100 includes a plurality of NN models. As described later using FIG. 4, the camera apparatus 200 acquires information (model information) relating to the NN models before the NN models are acquired from the lens apparatus 100. In the present embodiment described herein, three NN models, model 1, model 2, and model 3 are used.

The model information includes information 611 relating to the model 1, information 612 relating to the model 2, and information 613 relating to the model 3. Also, the information 611, 612, and 613 relating to the models 1, 2, and 3, respectively, each include an NN model layer number 601, an NN model matrix operation required number 602, and an NN model image processing performance 603.

In the present embodiment, to facilitate description, the relative image quality, that is the image processing result, acquired using the models 1, 2, and 3 is used as the image processing performance 603, but in actuality this represents a characteristic when correcting an image captured using the lens apparatus 100.

Also, in the present embodiment, to facilitate description, the relative image processing performance of the models 1, 2, and 3 is used, but in actuality this represents the correction processing performance of captured images based on the optical characteristics of the lens apparatus 100.

The model 1 has the lowest layer number 601 and also the lowest matrix operation required number 602, and so accordingly the model image processing performance 603 is the worst. For the model 2, the matrix operation required number 602 is in between that of the model 1 and the model 3, and the image processing performance 603 is in between them as well. The model 3 has the highest matrix operation required number and the image processing performance 603 is also the best.

Next, the operations of the camera apparatus 200 of the present embodiment will be described with reference to the flowchart of FIG. 4.

In step S401, the camera control unit 205 acquires the type information of the lens apparatus 100. The camera control unit 205 acquires the information relating to NN models stored in the lens apparatus 100 connected to the camera apparatus 200 from the type information of the lens apparatus 100. The information relating to NN models is the model information listed in FIG. 6.

In step S402, the camera control unit 205 determines whether or not the lens apparatus 100 connected to the camera apparatus 200 includes an NN model. The camera control unit 205 determines whether or not an NN model that enables processing (hereinafter, referred to as optical correction of the lens apparatus 100) to correct an image captured using the lens apparatus 100 connected to the camera apparatus 200 on the basis of the optical characteristic of the lens apparatus 100 is stored in the storage unit 151 of the lens apparatus 100.

In the present embodiment, whether or not an NN model is stored in the storage unit 151 of the lens apparatus 100 is determined. However, no such limitation is intended, and whether or not an NN model is in an external device, for example, may be determined. In this case, a communicative connection to the external device via a network is required.

When the camera control unit 205 determines that the lens apparatus 100 includes an NN model, the camera control unit 205 proceeds the processing to step S403. When the camera control unit 205 determines that the lens apparatus 100 does not include an NN model, the camera control unit 205 proceeds the processing to step S409.

In step S403, the camera control unit 205 determines whether or not image processing using the NN model can be executed by the image processing unit 203. At this time, the camera control unit 205 determines whether or not the image processing unit 203 can complete the NN model calculation processing within a predetermined amount of time.

In the present embodiment, whether or not the image processing unit 203 of the camera apparatus 200 can execute image processing using the NN model is determined. However, no such limitation is intended, and whether or not an external device communicatively connected via a network can execute image processing using the NN model may be determined.

When the camera control unit 205 determines that the image processing unit 203 can execute image processing using the NN model, the camera control unit 205 proceeds the processing to step S404. When the camera control unit 205 determines that the image processing unit 203 cannot execute image processing using the NN model, the camera control unit 205 proceeds the processing to step S409.

In step S409, the camera control unit 205 acquires optical information relating to the optical characteristics of the lens from the lens apparatus 100. The camera control unit 205 transmits an optical information request to the lens apparatus 100 using the camera data signal DCL and acquires the optical information of the lens using the lens data signal DLC received from the lens apparatus 100.

In step S410, the camera control unit 205 executes normal rulebook based image processing without the image processing unit 203 using a neural network, and the camera control unit 205 terminates the processing.

In step S404, the camera control unit 205 determines whether or not the image processing unit 203 has the performance required to execute image processing using the NN model. The camera control unit 205 determines the performance of the image processing using the NN model that the image processing unit 203 can execute. Since the camera control unit 205 acquires information relating to the number of layers and amount of time required for matrix operation of the NN models included in the lens apparatus 100 in step S401, the camera control unit 205 can calculate the processing time in the case of executing image processing using the NN models on the basis of the acquired information and the calculation processing power of the image processing unit 203.

When the camera control unit 205 determines that the image processing unit 203 can complete image processing A3 illustrated in FIG. 6 within a predetermined amount of time, the camera control unit 205 proceeds the processing to step S405. When the camera control unit 205 determines that the image processing unit 203 cannot complete image processing A3 but can complete image processing A2 within the predetermined amount of time, the camera control unit 205 proceeds the processing to step S406. When the camera control unit 205 determines that the image processing unit 203 cannot complete the image processing A2 within the predetermined amount of time, the camera control unit 205 proceeds the processing to step S407. In the present embodiment, a camera apparatus that can execute image processing using the NN model includes, as the minimum performance, the capability to execute the image processing of the model 1 within the predetermined amount of time. Whether or not the image processing of the model 1 can be completed within the predetermined amount of time is already determined in step S403.

Also, the predetermined amount of time for determining whether or not image processing using the NN model can be executed can be arbitrarily set by the user and may correspond to the frame rate when recording moving images.

In step S405, the camera control unit 205 acquires the NN model 3 from the lens apparatus 100.

In step S406, the camera control unit 205 acquires the NN model 2 from the lens apparatus 100.

In step S407, the camera control unit 205 acquires the NN model 1 from the lens apparatus 100.

In steps S405 to S407, the camera apparatus 200 transmits an NN model request to the lens apparatus 100 using the camera data signal DCL and acquires the NN model using the lens data signal DLC received from the lens apparatus 100.

In step S408, the camera control unit 205 executes image processing using the NN model acquired by the image processing unit 203 in steps S405 to S407, and the camera control unit 205 terminates the processing.

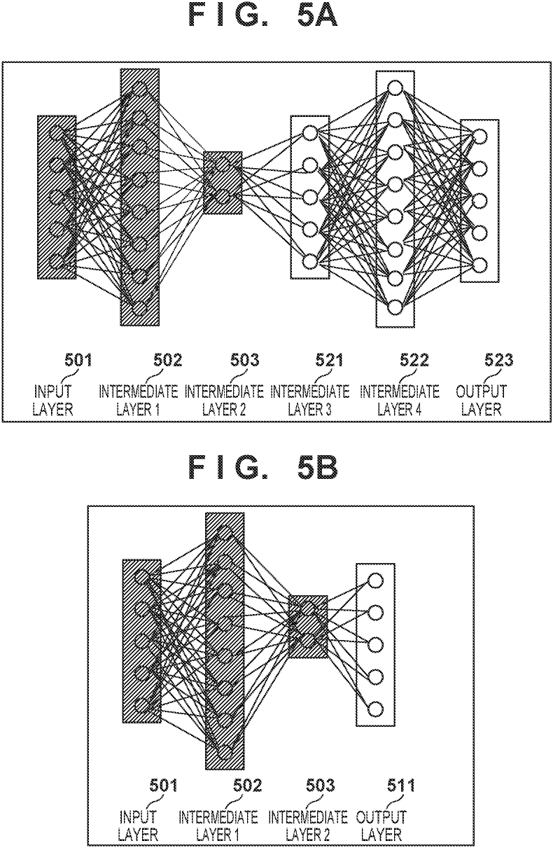

Next, the learning processing of the plurality of NN models held in the lens apparatus 100 will be described with reference to FIGS. 5A and 5B.

FIG. 5A illustrates the learning processing corresponding to the model 1 in FIG. 6, and FIG. 5B illustrates the learning processing corresponding the model 2 in FIG. 6. In the present embodiment, description of the model 3 is omitted.

As illustrated in FIGS. 5A and 5B, in the learning processing of the NN models (trained model generation processing), the learning processing is the same for the NN model 1 and the NN model 2 until a predetermined layer of the intermediate layer (in the example illustrated in FIGS. 5A and 5B, an input layer (501), an intermediate layer 1 (502), and an intermediate layer 2 (503)).

For the intermediate layers that are not the same, the node number (number of operations for the layer) for each intermediate layer may be arbitrarily set.

In the present embodiment, the learning processing of the NN models is executed in advance using a personal computer (PC) or the like with advanced calculation processing power.

In the present embodiment described herein, the layers that are in common are the layers until the intermediate layer 2 (503). However, no such limitation is intended, and until which layer of the intermediate layer are common layers may be arbitrarily set within a range that does not affect the calculation processing accuracy of the plurality of NN models.

First, learning processing is executed using the input layer (501), the intermediate layer 1 (502), the intermediate layer 2 (503), and an output layer (511) of the model 2 illustrated in FIG. 5B, and optimal parameters are set. The parameters can be arbitrarily changed by the user. After the learning processing illustrated in FIG. 5B is complete, the learning processing of the model 1 illustrated in FIG. 5A is executed. In the learning processing of the model 1 of FIG. 5A, the parameters of the input layer (501), the intermediate layer 1 (502), and the intermediate layer 2 (503) are not changed. An intermediate layer 3 (521), an intermediate layer 4 (522), and an output layer (523) of the model 2 of FIG. 5B change the parameters to optimal parameters at the right time via learning processing.

By executing learning processing of the NN models in this manner, the parameters of one or more of the plurality of NN models can be shared, and the capacity required for the storage unit 151 of the lens apparatus 100 can be minimized.

As described above, according to the second embodiment, optimal image processing for a lens apparatus without an NN model or a camera apparatus that cannot execute image processing using an NN model can be executed.

Also, since the lens apparatus 100 includes a plurality of NN models, image processing using the optimal NN model for the image processing performance of the image processing unit 203 of the camera apparatus 200 can be executed.

Also, when the lens apparatus 100 includes a plurality of NN models, by sharing the parameters of one or more of the plurality of NN models, the capacity required by the storage unit 151 of the lens apparatus 100 can be minimized.

Furthermore, the amount of time required for communications when transmitting the plurality of NN models from the lens apparatus 100 to the camera apparatus 200 can be shortened.

### Third Embodiment

Next, the third embodiment will now be described.

In the third embodiment, the processing for reducing the capacity required by the storage unit 151 of the lens apparatus 100 compared to the first and second embodiments will be described.

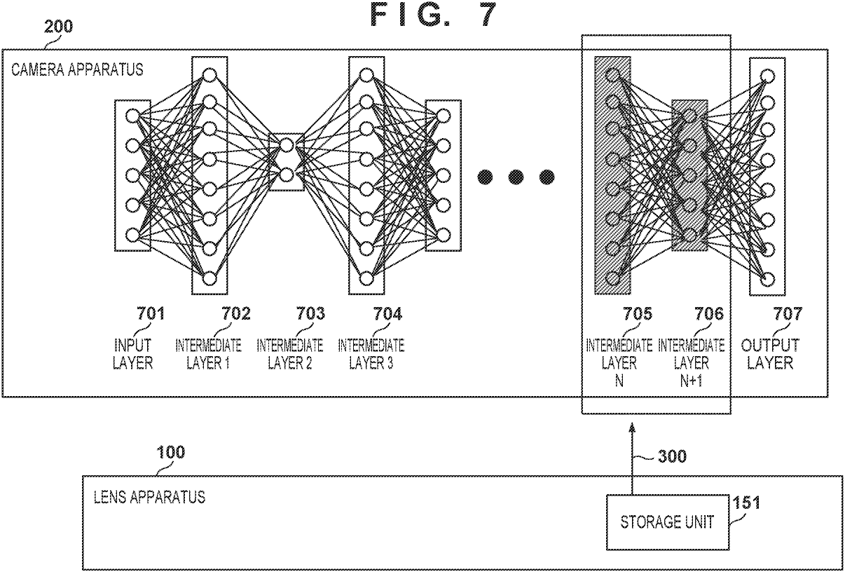

FIG. 7 illustrates an example of a stored state of a NN model by a camera apparatus and a lens apparatus of the present embodiment.

The NN model includes an input layer, N + 1 intermediate layers, and an output layer. Herein, the layers are defined as an input layer (701), an intermediate layer 1 (702), an intermediate layer 2 (703), an intermediate layer 3 (704), an intermediate layer N (705), an intermediate layer N + 1 (706), and an output layer (707).

The storage unit 204 of the camera apparatus 200 stores a first portion of the NN model including the input layer (701), the intermediate layer 1 (702), the intermediate layer 2 (703), the intermediate layer 3 (704), the intermediate layers 4 to N - 1, and the output layer (707).

The storage unit 151 of the lens apparatus 100 stores a second portion of the NN model including the intermediate layer N (705) and the intermediate layer N + 1 (706).

The layers from the input layer (701) to the intermediate layer N - 1, that is the first portion, are not dependent on the optical information of the lens apparatus 100 and have fixed parameters, and common parameters are set for whichever lens is used.

The intermediate layer N (705) and the intermediate layer N + 1 (706), that is the second portion, are dependent on the optical information of the lens apparatus 100 and have changing parameters, and the parameters set change depending on the lens type of the lens apparatus 100.

In the present embodiment described herein, the intermediate layer N (705) and the intermediate layer N + 1 (706) are dependent on the optical information of the lens apparatus 100 and have changing parameters. However, no such limitation is intended, and it is sufficient that appropriate parameters are set for the layer where the optical correction of the lens apparatus 100 is performed.

First, as in the second embodiment, a plurality of NN models are prepared for optical correction of the lens apparatus 100, and the NN models may be changed according to the image processing performance of the image processing unit 203 of the camera apparatus 200. Even in this case, a portion of the NN model (only the layer where optical correction is performed) can be stored in the storage unit 151 of the lens apparatus 100, and thus a storage capacity less than that of the second embodiment can be implemented.

In the present embodiment described herein, in the NN model, the output layer (707) is the stage after the intermediate layer N + 1 (706). However, for example, one or more intermediate layers may be added between the intermediate layer N + 1 (706) and the output layer (707) depending on the type of the image processing executed by the camera apparatus 200.

For example, when image output is desired to be executed or when super-resolution processing is desired to be executed, depending on the image processing content, the NN model stored in the storage unit 204 of the camera apparatus 200 may be arbitrarily changed. In the present embodiment, only the appropriate layer number, that is the layers where optical correction of the lens apparatus 100 is executed, and the parameter model are stored in the storage unit 151 of the lens apparatus 100, and the other parameters are stored in the storage unit 204 of the camera apparatus 200.

The method of the camera apparatus 200 acquiring the NN model of the intermediate layer N (705) and the intermediate layer N + 1 (706) from the lens apparatus 100 is the same as described in the first and second embodiments.

Next, the learning processing of the NN model according to the third embodiment will be described. The learning processing of the present embodiment is executed in advance using a PC or the like with advanced calculation processing power.

First, arbitrary one lens apparatus 100 is connected, and learning processing is executed. In this case, the parameters can be freely changed.

After the learning processing is complete, the parameters from the input layer (701), the intermediate layer 1 (702), the intermediate layer 2 (703), the intermediate layer 3 (704) to the intermediate layer N - 1 are stored in the storage unit 204 of the camera apparatus 200. Also, the portions of the intermediate layer N (705) and the intermediate layer N + 1 (706) are stored in the storage unit 151 of the arbitrarily connected lens apparatus 100.

Thereafter, a different lens apparatus 100 is connected, and learning processing is executed. At this time, the parameters of the input layer (701), the intermediate layer 1 (702), the intermediate layer 2 (703), the intermediate layer 3 (704) to the intermediate layer N - 1 are not changed. In the different lens apparatus 100, the parameters to be changed are restricted to the intermediate layer N (705) and the intermediate layer N + 1 (706). Learning processing with only the parameters of the intermediate layer N (705) and the intermediate layer N + 1 (706) being changed for each different lens apparatus is executed in this manner, and the learning result of each lens apparatus is stored.

As described above, until which layer of the intermediate layers are common layers with fixed parameters independent of the lens apparatus may be arbitrarily determined within a range that does not affect the calculation processing accuracy of the NN model. Also, in the present embodiment described herein, two layers, the intermediate layer N (705) and the intermediate layer N + 1 (706), are used irrespective of the type of the lens apparatus. However, the number of layers can be freely changed for each type of the lens apparatus 100.

In the learning processing of the present embodiment, the parameters that change for each lens apparatus are set in the stage after the intermediate layer. This is because this is suitable when executing NN model transfer learning, and since learning processing is executed with fixed parameters in the stage previous to the intermediate layer, different parameters are set for the layers after for each lens apparatus. Also, when various types of image processing are desired to be executed using the camera apparatus 200, a layer appropriate for the type of image processing may be further added after the intermediate layer N + 1 (706). Furthermore, when the image processing is different, the parameters from the input layer (701), the intermediate layer 1 (702), the intermediate layer 2 (703), the intermediate layer 3 (704) to the intermediate layer N - 1 may be stored in the storage unit 204 of the camera apparatus 200 and may be switched depending on the mode of the camera apparatus 200. In this manner, when the image processing is different and the NN model itself is changed, it is necessary to prepare more than one intermediate layer N (705) and intermediate layer N + 1 (706) of different parameters for each lens apparatus 100.

Storing the NN model acquired from the lens apparatus 100 in the storage unit 204 of the camera apparatus 200 removes the need for model transmission each time the lens apparatus 100 is connected and enables the amount of time taken from connection of the second and onward lens apparatus to image processing to be shortened.

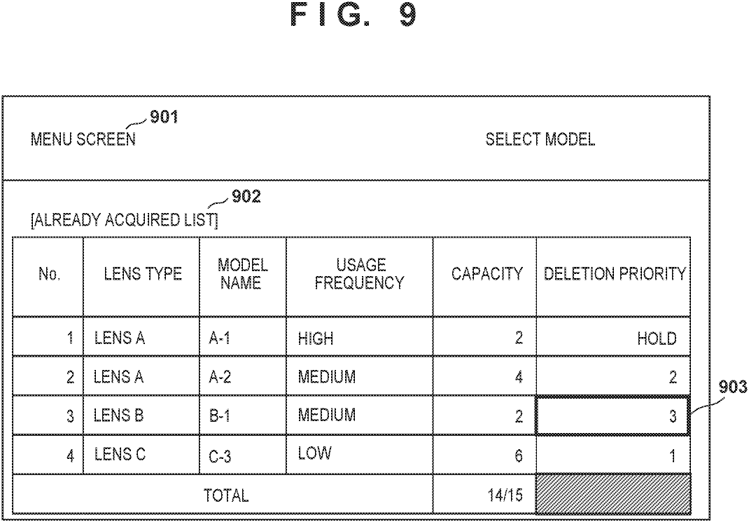

Next, the management UI of the NN model stored in the storage unit 204 of the camera apparatus 200 will be described with reference to FIG. 9.

On a menu screen 901, a description of the function of the screen, such as NN model selection, is displayed. In an acquired list 902, NN models already stored in the storage unit 204 of the camera apparatus 200 are displayed. In the acquired list 902, information indicating the lens type, information indicating the NN model, information indicating the capacity required by the storage unit 204 of the camera apparatus 200, and priority of information deletion in case of connection by unregistered lens apparatus are displayed. Note that the number displayed in the acquired list 902 does not relate to the priority order but is a number for identifying the place where the subject is stored. Also, even when the lens type is different, the information indicating the NN model may be the same.

When an unregistered lens apparatus is connected to the camera apparatus, a selection frame 903 for the information deletion priority indicating the priority selected by the user is displayed. When the priority is not selected by the user, the model with the lowest usage frequency may be prioritized and deleted, or the date and time, not illustrated in the present embodiment, of when the lens apparatus 100 connected may be managed, with the models being deleted in order from the oldest date and time. Also, since lens A includes a plurality of NN models, the deletion priority may be raised.

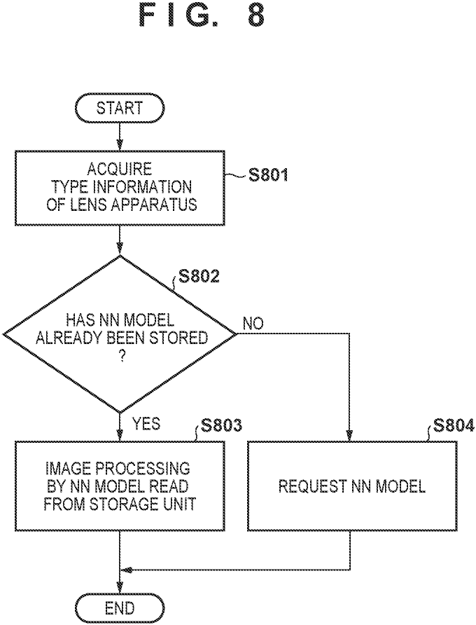

Next, the initial operations of the camera apparatus 200 in a case of the camera apparatus 200 having already acquired the NN model of the lens apparatus 100 and stored it in the storage unit 204 and in a case otherwise will be described with reference to FIG. 8.

In step S801, the camera control unit 205 acquires the type information of the lens apparatus 100. The camera control unit 205 acquires the information relating to NN models stored in the lens apparatus 100 connected to the camera apparatus 200 from the type information of the lens apparatus. The information relating to the NN model is information relating to the number of layers and amount of processing time required.

In step S802, the camera control unit 205 determines whether or not the NN model of the lens apparatus 100 connected to the camera apparatus 200 is already stored in the storage unit 204. When the camera control unit 205 determines that the NN model of the lens apparatus 100 connected to the camera apparatus 200 is already stored in the storage unit 204, the camera control unit 205 proceeds the processing to step S803. When the camera control unit 205 determines that the NN model of the lens apparatus 100 connected to the camera apparatus 200 is not already stored in the storage unit 204, the camera control unit 205 proceeds the processing to step S804.

In step S803, the camera control unit 205 does not acquire the NN model from the lens apparatus 100 connected to the camera apparatus 200, reads out the model already stored in the storage unit 204 of the camera apparatus 200, and executes image processing using the NN model. With this configuration, the amount of time taken from connection of the second and onward lens apparatus to image processing can be shortened.

In step S804, the camera control unit 205 transmits a NN model acquisition request to the lens apparatus 100 connected to the camera apparatus 200. The subsequent processing is the same as described using FIG. 3. In step S804, until the parameters of the intermediate layer N (705) and the intermediate layer N + 1 (706) are acquired from the lens apparatus 100, image processing may be executed using from the input layer (701), the intermediate layer 1 (702), the intermediate layer 2 (703), the intermediate layer 3 (704) to the intermediate layer N -1, and the output layer (707). With this configuration, when the first lens apparatus is connected, the amount of time until image processing can be shortened, but since the parameters of the intermediate layer N (705) and the intermediate layer N + 1 (706) cannot be acquired, the image processing performance is reduced. After the parameters of the intermediate layer N (705) and the intermediate layer N + 1 (706) are acquired from the lens apparatus 100, the acquired NN model is added and image processing is executed. Then, the processing is terminated.

As described above, according to the third embodiment, by sharing the load of the NN model between the camera apparatus 200 and the lens apparatus 100, the capacity required by the storage unit 151 of the lens apparatus 100 can be minimized.

Also, the amount of time taken to transmit the NN model from the lens apparatus 100 to the camera apparatus 200 can be shortened.

Furthermore, since the lens apparatus 100 holds one or more of the plurality of NN models, optimal image processing with a neural network for the calculation processing power of the image processing unit 203 of the camera apparatus 200 can be executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-032810, filed Mar. 3, 2022 which is hereby incorporated by reference herein in its entirety.

What is claimed is:

1. An image capture apparatus comprising:
a connection unit that connects to an accessory apparatus;
an image processing unit that executes image processing using a learning model; and
a control unit that acquires a learning model to be used by the image processing unit in image processing from the accessory apparatus connected to the image capture apparatus.

2. The apparatus according to claim 1, wherein
the control unit selects one of a plurality of learning models included in the accessory apparatus according to a calculation processing power of the image processing unit and requests a transmission of the selected model to the accessory apparatus.

3. The apparatus according to claim 2, wherein
the calculation processing power of the image processing unit includes an amount of time required for image processing for each learning model, and
whether or not the amount of time required for image processing is within a predetermined amount of time is determined.

4. The apparatus according to claim 3, wherein
the control unit includes a setting unit that sets the predetermined amount of time in accordance with a user operation and selects one of the plurality of learning models in accordance with the predetermined amount of time set by the setting unit and requests a transmission of the selected learning model to the accessory apparatus.

5. The apparatus according to claim 1, wherein
the accessory apparatus is a lens apparatus, and
the learning model is a neural network model for correcting an image captured using the lens apparatus.

6. The apparatus according to claim 1, further comprising
a storage unit that stores a first portion of the learning model, wherein
the control unit acquires a second portion of the learning model from the accessory apparatus, and
the image processing unit executes image processing using the learning model including the first portion and the second portion.

7. The apparatus according to claim 6, wherein
the accessory apparatus is a lens apparatus, and
the learning model is a neural network model for correcting an image captured using the lens apparatus.

8. The apparatus according to claim 7, wherein
the control unit selects one of a plurality of learning models included in the accessory apparatus according to a calculation processing power of the image processing unit and requests a transmission of the second portion of the selected model to the accessory apparatus.

9. The apparatus according to claim 8, wherein
the first portion is a portion of the neural network model from an input layer to a predetermined intermediate layer, and
the second portion is a portion from an intermediate layer subsequent to the first portion to an output layer.

10. The apparatus according to claim 8, wherein
the first portion is a portion of the neural network model from an input layer to a predetermined intermediate layer and an output layer, and
the second portion is a portion including an intermediate layer subsequent to the first portion.

11. The apparatus according to claim 7, wherein
in learning processing of the neural network model,
a parameter of the first portion of the neural network model is fixed and independent of the lens apparatus, and
a parameter of the second portion of the neural network model changes depending on the lens apparatus.

12. An accessory apparatus which is connectable to an image capture apparatus, comprising:
a storage unit that stores a learning model appropriate for a type of the accessory apparatus; and
a control unit that transmits the learning model stored in the storage unit to the image capture apparatus in response to a request from the image capture apparatus.

13. The apparatus according to claim 12, wherein
the storage unit stores a plurality of learning models, and
the control unit transmits one of the plurality of learning models to the image capture apparatus in response to a request from the image capture apparatus.

14. The apparatus according to claim 12, wherein
the accessory apparatus is a lens apparatus,
the learning model is a neural network model for correcting an image captured using the lens apparatus,
the storage unit stores optical information relating to an optical characteristic of the lens apparatus, and
the control unit transmits the optical information to the image capture apparatus in response to a request from the image capture apparatus.

15. The apparatus according to claim 14, wherein
in learning processing of the neural network model, a parameter of the neural network model from an input layer to a common intermediate layer is fixed regardless of the lens apparatus.

16. The apparatus according to claim 12, wherein
the storage unit stores a second portion of the learning model, and
the control unit transmits the second portion of the learning model stored in the storage unit to the image capture apparatus in response to a request from the image capture apparatus.

17. The apparatus according to claim 13, wherein
the storage unit stores a second portion of the plurality of learning models, and
the control unit transmits the second portion of one of the plurality of learning models to the image capture apparatus in response to a request from the image capture apparatus.

18. The apparatus according to claim 16, wherein
the accessory apparatus is a lens apparatus,
the learning model is a neural network model for correcting an image captured using the lens apparatus.

19. The apparatus according to claim 18, wherein
the neural network model includes a first portion and a second portion,
the first portion is a portion of the neural network model from an input layer to a predetermined intermediate layer, and
the second portion is a portion from an intermediate layer subsequent to the first portion to an output layer.

20. The apparatus according to claim 18, wherein
the neural network includes a first portion and a second portion,
the first portion is a portion of the neural network model from an input layer to a predetermined intermediate layer and an output layer, and
the second portion is a portion including an intermediate layer subsequent to the first portion.

21. The apparatus according to claim 19, wherein
in learning processing of the neural network model,
a parameter of the first portion of the neural network model is fixed regardless of the lens apparatus, and
a parameter of the second portion of the neural network model changes depending on the lens apparatus.

22. A method of controlling an image capture apparatus provided with a connecting unit that connects to an accessory apparatus and an image processing unit that executes image processing using a learning model, the method comprising:
acquiring a learning model to be used by the image processing unit in image processing from the accessory apparatus connected to the image capture apparatus.

23. A method of controlling an accessory apparatus which is connectable to an image capture apparatus, the method comprising:
receiving a request for a learning model appropriate for a type of the accessory apparatus from the image capture apparatus; and
transmitting a learning model stored in a storage unit to the image capture apparatus in response to a request from the image capture apparatus.

24. A non-transitory computer-readable storage medium storing a program that causes a computer to execute a method of controlling an image capture apparatus provided with a connecting unit that connects to an accessory apparatus and an image processing unit that executes image processing using a learning model, the method comprising:
acquiring a learning model to be used by the image processing unit in image processing from the accessory apparatus connected to the image capture apparatus.

25. A non-transitory computer-readable storage medium storing a program that causes a computer to execute a method of controlling an accessory apparatus which is connectable to an image capture apparatus, the method comprising:
receiving a request for a learning model appropriate for a type of the accessory apparatus from the image capture apparatus; and
transmitting a learning model stored in a storage unit to the image capture apparatus in response to a request from the image capture apparatus.
